(19) United States
(12) Patent Application Publication
(10) Pub. No.: US 2013/0215706 A1
(43) Pub. Date: Aug. 22, 2013

(54) METHOD AND APPARATUS FOR CREATING CAVITATION FOR BLENDING AND EMULSIFYING

(71) Applicants: Charles D. Markert, Purcellville, VA (US); Paul G. Delozier, Flint Hill, VA (US)

(72) Inventors: Charles D. Markert, Purcellville, VA (US); Paul G. Delozier, Flint Hill, VA (US)

(73) Assignee: CAVITRONIX CORPORATION, Front Royal, VA (US)

(21) Appl. No.: 13/698,720

(22) PCT Filed: May 18, 2011
(86) PCT No.: PCT/US11/37004

§ 371 Date: Jan. 30, 2013

Related U.S. Application Data
(60) Provisional application No. 61/346,072, filed on May 19, 2010.

(51) Int. Cl. B01F 5/02

(52) U.S. Cl. CPC B01F 5/0268
USPC 366/175.2

(57) ABSTRACT

The present invention relates to a device for emulsifying a mixture. The device includes a body defining a cavitation chamber, the body comprising a first and second opening and the cavitation chamber comprising an entry port and an exit port. The first opening is connected to the entry port and the second opening is connected to the exit port. The device includes a replaceable nozzle positioned in the entry port and an adjustable counter baffle positioned in the cavitation chamber to impinge flow of solution entering the cavitation chamber from the nozzle. Also disclosed is a method of emulsifying a mixture. This method involves providing the device of the present invention, introducing a mixture into the first opening of the device, and recovering an emulsified solution from the second opening of the device.

This application claims the priority benefit of U.S. Provisional Patent Application Ser. No. 61/346,072, filed May 19, 2010, which is hereby incorporated by reference in its entirety.

### FIELD OF THE INVENTION

The present invention relates to a device and method for creating cavitation for blending and emulsifying.

### BACKGROUND OF THE INVENTION

Emulsion technology has uses in a wide variety of industrial settings, including, for example, the food products industry, cosmetics industry, medicine, pharmaceuticals, medical processes and procedures, oil and gas processing, water treatment, and alternative fuels. In most cases, high fluid pressure and multiple fluid and chemical emulsifiers or additives are needed to produce a stable emulsion product. Often, the desire is to obtain nanometer structured emulsion droplets, which are thought to benefit the final properties of the emulsion. The quality of an emulsion is often judged based on the shelf-life (i.e., the avoidance of fluid separation over time) of the emulsion.

Water-in-oil emulsion has steadily gained credibility from a public perception standpoint as a useful and beneficial fuel in industry. Water-in-oil emulsions are primarily made with the use of emulsifiers or surfactants and are not stable enough to be free of separation over time. Products are being made and tested to better and more effectively deliver water-in-oil emulsion to the point of use by boiler burners and engines.

The primary function of an emulsifier is to help make droplets of discontinuous/dispersed substances in solutions small and to keep those droplets small by reducing surface tension and thereby retarding the droplet coalescence process. The current state of the art of emulsion technology includes various devices and processes for making emulsions by way of ultrasonic, mechanical, and hydrodynamic means. These methods include, for example, forcing flowing liquids and substances under pressure through flow redirection means which enhance fluid turbulence conditions. Turbulence, in conjunction with the resulting cavitation energy from a significant pressure drop, causes immiscible liquids (liquids that do not dissolve into one another) and/or contained substances to form a combined liquid emulsion or colloid. A colloid is defined as a heterogeneous mixture in which very small particles of a substance are dispersed in another medium. Although sometimes referred to as colloid solutions, the dispersed particles are typically much larger than molecular scale. Heterogeneous mixtures that are two or more liquid phases are defined as emulsions.

In one device described in U.S. Pat. No. 2,271,982 to Kreveld, a means for homogenizing (transforming the chemical composition, appearance, and properties throughout a material) liquids and mixtures containing liquid matter is described. This device is utilized under a high pressure in the range of 200 atmospheres, but suffers from a limited ability to control various cavitation, turbulence, flow, and pressure parameters in the cavitation chamber.

Achieving desirable liquid emulsions or colloids depends on the ability to control and manipulate the droplet size of dispersed substances in solutions and create or maintain a stable solution in the presence of a wide range of emulsifiers.

The complexity of many emulsion technology systems is high. Moreover, the processes can be very complex and elaborate. For example, many mechanical devices used in emulsion technology are complex and/or have moving parts, require frequent repair, and can be unreliable. Thus, there is a need for devices and methods that produce more efficient emulsions to lower costs per unit volume of end product.

The present invention is directed to overcoming these and other limitations in the art.

### SUMMARY OF THE INVENTION

One aspect of the present invention relates to a device for emulsifying a mixture. The device includes a body defining a cavitation chamber, the body comprising a first and second opening and the cavitation chamber comprising an entry port and an exit port. The first opening is connected to the entry port by which a mixture enters the body and the cavitation chamber to be emulsified and the second opening is connected to the exit port by which emulsified solution exits the cavitation chamber and the body. The device also includes a replaceable nozzle positioned in the entry port of the cavitation chamber to direct flow of solution into the cavitation chamber and an adjustable counter baffle positioned in the cavitation chamber at a position to impinge flow of solution entering the cavitation chamber from the nozzle. The counter baffle is moveably attached to the body to allow adjustment of distance between the counter baffle and the nozzle.

Another aspect of the present invention relates to a method of emulsifying a mixture. This method involves providing the device of the present invention and introducing a mixture into the first opening of the device. The mixture passes through the nozzle and is emulsified in the cavitation chamber. An emulsified solution is recovered from the second opening of the device.

The present invention relates to blending and emulsifying immiscible liquids and other substances. The device and method of the present invention provide a means to achieve high-shear forces to impart high energy input into fluid streams and, more particularly, to mixing immiscible liquids and other substances to form emulsions through the use of controlled fluid turbulence and cavitation energy. Cavitation can be defined for the purposes of this invention as the breaking of a liquid medium under excessive stresses.

The device and method of the present invention are significant advances in the refinement of devices and methods that create highly effective and useful water-in-oil emulsions. The present invention provides a simple, no moving parts, hydrodynamic emulsion producing device that can be used at pressures and flows much lower than other conventional devices. The device and method of the present invention can be used to produce, among other emulsions, water-in-oil emulsions that are produced on demand at their final point of use without the need for having long-term shelf-life or stability. For example, one such use is for forming water in fuel emulsions for use at the fuel consumption point such as for oil fired boilers, turbines, and internal and external combustion engines for either stationary or mobile units.

The device and method of the present invention take maximum advantage of previously unknown or misunderstood capabilities in emulsion technologies. The device of the present invention can operate at low or high pressures in conjunction with structural features that collectively provide for a more effective, diverse, and efficient production of emulsions for uses beyond those that could be accomplished with existing technologies.

### BRIEF DESCRIPTION OF THE DRAWINGS

FIG. 1 is a perspective view of a longitudinal cross-section of one embodiment of a device for emulsifying a solution of the present invention.

FIG. 2 is a plan view of a longitudinal cross-section of one embodiment of a device for emulsifying a solution of the present invention.

FIG. 3 is an exploded, plan view of a longitudinal cross-section of one embodiment of a device for emulsifying a solution of the present invention.

FIG. 4 is a plan view of a longitudinal cross section of one embodiment of a device for emulsifying a solution of the present invention. Arrows are provided to show the directional flow of the bulk of the solution from left to right into and out of the device.

FIG. 5 is a plan view of a longitudinal cross section of one embodiment of the impact area of the counter baffle component of the device of the present invention.

FIG. 6 is a plan view of a longitudinal cross section of one embodiment of the impact area of the counter baffle component of the device of the present invention.

FIG. 7 is a plan view of a longitudinal cross section of one embodiment of the impact area of the counter baffle component of the device of the present invention.

FIG. 8 is a plan view of a longitudinal cross section of one embodiment of the replaceable nozzle component of the device of the present invention.

FIG. 9 is a plan view of a longitudinal cross section of one embodiment of the replaceable nozzle component of the device of the present invention.

FIG. 10 is a plan view of a longitudinal cross section of one embodiment of the replaceable nozzle component of the device of the present invention.

### DETAILED DESCRIPTION OF THE INVENTION

One aspect of the present invention relates to a device for emulsifying a mixture. The device includes a body defining a cavitation chamber, the body comprising a first and second opening and the cavitation chamber comprising an entry port and an exit port. The first opening is connected to the entry port by which mixture enters the body and the cavitation chamber to be emulsified and the second opening is connected to the exit port by which emulsified solution exits the cavitation chamber and the body. The device also includes a replaceable nozzle positioned in the entry port of the cavitation chamber to direct flow of solution into the cavitation chamber and an adjustable counter baffle positioned in the cavitation chamber at a position to impinge flow of solution entering the cavitation chamber from the nozzle. The counter baffle is moveably attached to the body to allow adjustment of distance between the counter baffle and the nozzle.

As used herein, the phrase “emulsifying a mixture” is used to refer to the formation of an emulsion or colloid from two or more immiscible liquids. Emulsions are generally understood to include one liquid (referred to as the dispersed phase) dispersed in another liquid (referred to as the continuous phase). Thus, references to a “mixture” to be emulsified are intended to mean a mixture with two or more liquid heterogeneous components that can form an emulsion or colloid which may also contain liquid or gas components as well.

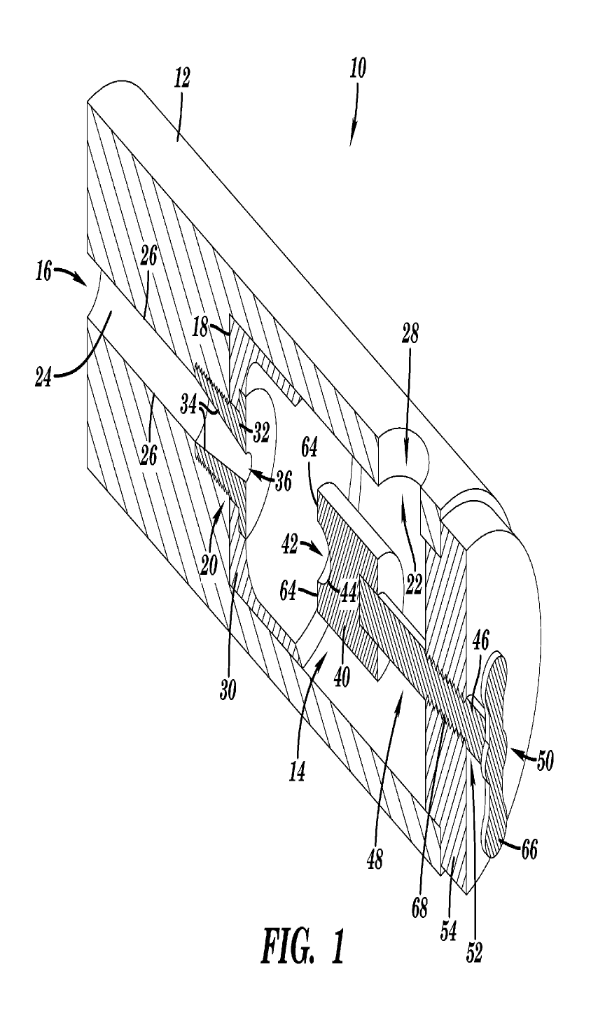

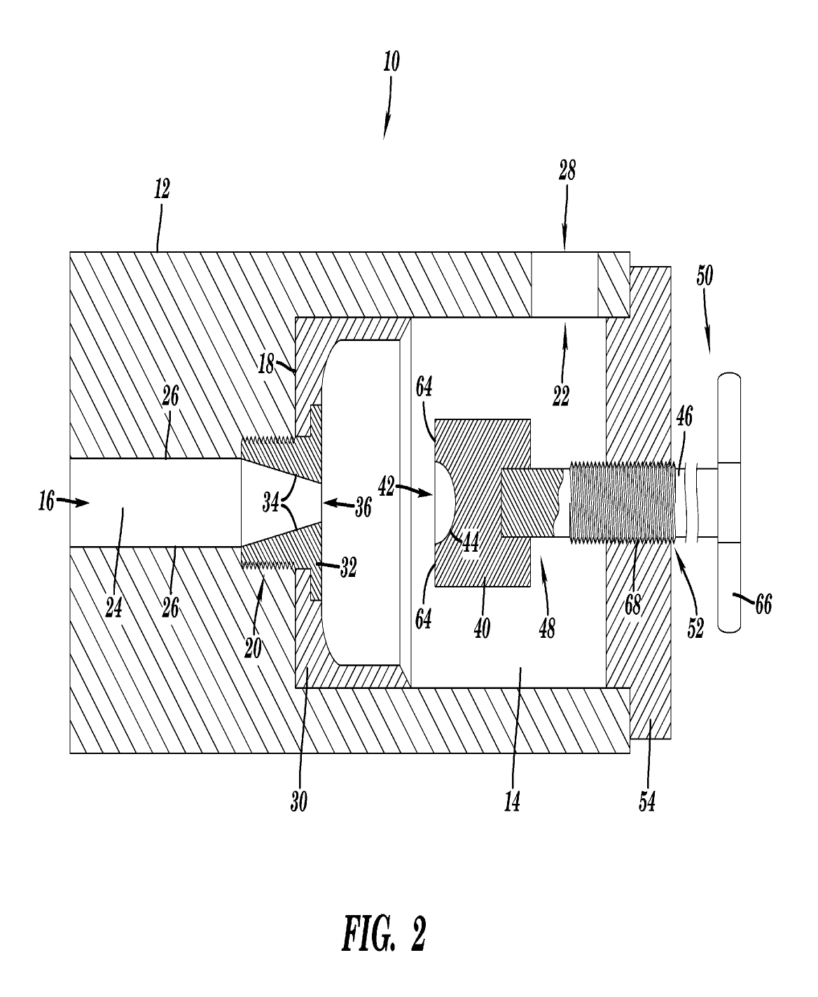

Referring now to FIG. 1 and FIG. 2, device 10 includes body 12 which defines cavitation chamber 14. Body 12 includes first opening 16 and second opening 28. In the particular embodiment illustrated in FIG. 1 and FIG. 2, second opening 28 is positioned at a location away from first opening 16 and in a plane perpendicular to the plane in which first opening 16 is positioned. First opening 16 is connected to entry port 20 of cavitation chamber 14 via channel 24. In the embodiment illustrated in FIG. 1 and FIG. 2, channel 24 is the interior of a right circular cylinder with wall 26. However, wall 26 of channel 24 may also be asymmetric.

Second opening 28 of body 12 is exit port 22 of cavitation chamber 14. In the embodiment illustrated in FIG. 1 and FIG. 2, cavitator insert 30 is positioned in cavitation chamber 14 against front wall 18. Cavitator insert 30 serves to clear the eddy current that would form in corners along front wall 18 that may interfere with flow. Cavitator insert 30 is, according to one embodiment of the present invention, made from a material resistant to cavitation damage over time.

First opening 16 and second opening 28 are, according to one embodiment, equipped with threaded coupling structures to permit the coupling of pipes, hoses, or other ancillary attachments into and out of device 10. In addition, first opening 16 and/or second opening 28 may be equipped with or connected to valve structures that can be adjusted to control the flow of solution into and out of device 10. Further, first opening 16 and/or second opening 28 are optionally equipped with sensing devices to monitor, e.g., flow rate, pressure, temperature, or other properties of solution entering and emulsion exiting device 10.

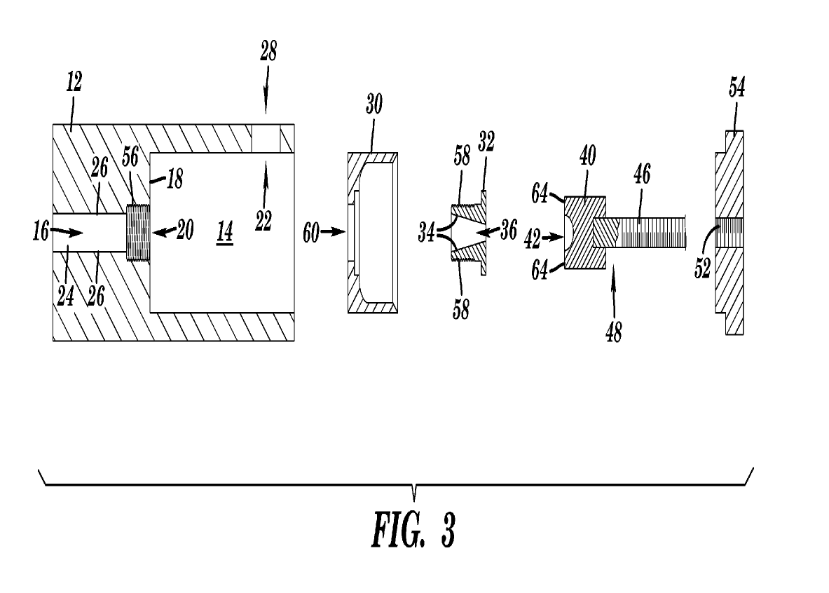

Device 10 has replaceable nozzle 32 positioned in entry port 20 of cavitation chamber 14. Replaceable nozzle 32 has nozzle walls 34 that lead to nozzle opening 36. Replaceable nozzle 32 is connected to channel 24. In the embodiment shown in FIG. 1 and FIG. 2, replaceable nozzle 32 fits into cavitator insert 30, which abuts front wall 18. As illustrated in FIG. 3, replaceable nozzle 32 is machined with male threads 58 that engage with female threaded bore 56 in channel 24 at entry port 20. Other means of positioning nozzle 32 at entry port 20 may also be used. In a preferred embodiment, there is a smooth and seamless transition between channel 24 and replaceable nozzle 32.

With further reference to FIG. 1 and FIG. 2, positioned in cavitation chamber 14 is adjustable counter baffle 40. Counter baffle 40 has impact area 42 which includes concave depression 44. In the particular embodiment shown in FIG. 1 and FIG. 2, impact area 42 has concave depression 44. As shown in FIG. 1 and FIG. 2, the projected area of concave depression 44 has a diameter greater than the diameter of nozzle opening 36. Also, concave depression 44 and land area 64 are not in contact with nozzle 32, cavitation insert 30, or front wall 18 (when cavitator insert 30 is not employed). Counter baffle 40 is held in place in cavitation chamber 14 by stem 46. Stem 46 has proximal end 48 and distal end 50. Proximal end 48 of stem 46 connects to counter baffle 40 inside cavitation chamber 14. In the particular embodiment shown in FIG. 1 and FIG. 2, stem 46 extends from the exterior of body 12 into cavitation chamber 14 through opening 52 in back wall 54.

Device 10 and its component parts may be constructed of well known materials generally used in liquid transport and mixing applications. Exemplary materials include, without limitation, stainless steel and nickel alloys that have a well documented high resistance to surface damage from known adverse fluid cavitation environments. In addition, the use of new state of the art metallurgical construction materials have the potential to significantly increase the useful lifetime of device 10. In one particular embodiment, the portions of device 10 that are exposed to solution (i.e., channels, walls, or chambers within device 10) have a high value Root Mean Squared (RMS) surface finish.

The physical size of device 10 can be accommodated to any particular application. In other words, device 10 is scalable to accommodate a wide range of pressure and flow conditions (discussed in more detail below), in addition to being able to use solutions with broad dynamic parameter ranges.

One of the particular advantages of device 10 is that it does not require any moving parts during the emulsification process. While nozzle 32 is replaceable and counter baffle 40 is adjustable, these components can be fixed and stationary during operation of device 10.

In operation, solution (i.e., a mixture to be emulsified) flows into device 10 through first opening 16, which travels down channel 24, through nozzle 32, and into cavitation chamber 14. Device 10 can accommodate most types of fluids that encompass a broad range of chemical and physical properties and any kind of solution, including solutions of a wide range of viscosities and fluid mixtures, including suspended solids. In one particular embodiment, solution entering opening 16 may include two or more immiscible liquids to be emulsified. For example, a solution containing a mixture of water and oil may enter device 10 at opening 16 and then exit device 10 at second opening 28 as an emulsion. Fluids may be introduced into first opening 16 with or without being previously mixed upstream. However, premixing of the initial pure fluids before introduction into opening 16 enhances the quality characteristics of the resulting emulsion effluent at second opening 28.

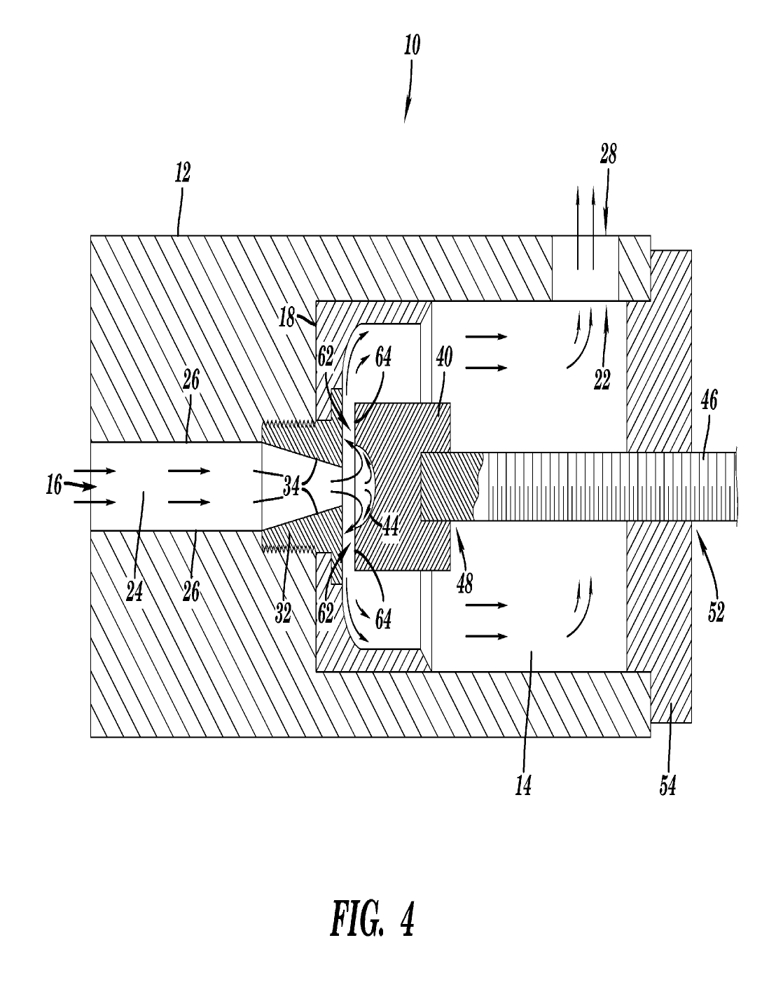

Turning now to FIG. 4, the flow of solution through device 10 is shown by directional arrows. As illustrated, solution flows through device 10 generally from left to right, with solution entering device 10 at opening 16 and flowing through channel 24 and nozzle 32 toward impact area 42 of counter baffle 40. In the particular embodiment illustrated in FIG. 4, impact area 42, at the apex of concave depression 44, is perpendicular to the flow of solution from nozzle 32 into cavitation chamber 14. In the particular embodiment illustrated in FIG. 4, the flow of the solution is impinged by impact with concave depression 44 to increase turbulent mixing of the fluids, impart additional energy into the fluids, change the velocity of the fluids, and force the fluids through channel 62. Volumetric channel 62 is bounded by the face of nozzle 32 and circumferential land area 64. Solution (i.e., an emulsion) then leaves cavitation chamber 14 through exit port 22 and exits device 10 through second opening 28.

As noted above, according to one embodiment of the present invention, it may be desirable for two or more liquids to be mixed before entering device 10 at first opening 16. Accordingly, initial mixing of the starting input substances can be achieved upstream of device 10 by, for example, passage through a conventional pressure-flow source such as a positive displacement gear pump and/or a conventional static mixing device either before or after a conventional pressure-flow source.

It is necessary for the solution entering device 10 to be pressurized. A suitable operating pressure for device 10 depends on many factors, including the types of solutions to be emulsified, the desired emulsion product, the particular design and/or shape of the components of device 10 and the particular requirements of the application under consideration. Typically, for a broad range of oil fired boilers, the operating pressure range would be approximately 5 to 25 atmospheres. Solution enters device 10 at a pressure of about 5 to 10 atmospheres. In one particular embodiment, input operating pressures for water in fuel emulsions are carried out in a range of about 6-8 atmospheres. Of course, it will be appreciated that higher (or lower) operating pressure ranges can be produced if required for other applications. As described in more detail infra, adjusting the pressure of solution entering device 10 is one of many factors affecting the final emulsion product. While certain uses of device 10 may achieve best results when solution enters opening 16 at a constant pressure, it may also be desirable to alter the pressure and/or rate of solution entering device 10 to achieve a particular result. One of the specific advantages of device 10 over other devices is its ability to deliver an emulsion with water droplets in the ranges most desired for many applications at a relatively low pressure compared to the 200 atmospheres of the device described in U.S. Pat. No. 2,271,982 to Kreveld.

While the pressure at which a solution entering device 10 at first opening 16 will effect the velocity at which the solution is impinged by concave depression 44 in impact area 42 of counter baffle 40, solution velocity is also controlled by the particular design of replaceable nozzle 32 that is employed. For example, replaceable nozzle 32 may have convergent walls 34 (as illustrated in FIG. 4) which, when encountered by fluid moving toward nozzle opening 36 will force an increase in the velocity of solution exiting nozzle opening 36, compared to its velocity in channel 24. In an alternative embodiment, walls 34 of replaceable nozzle 32 include a portion of small diameter channel between walls 34 and opening 36. In this particular embodiment, the velocity of the solution exiting nozzle opening 36 will depend on the area of opening 36, the angle of the constriction in walls 34, viscosity of the solutions, and the pressure being applied to the solutions.

The particular design of replaceable nozzle 32 can impact the essential flow conditions for cavitation in cavitation chamber 14, particularly when fluid is forced through a reducing flow area of a convergently shaped nozzle. Since nozzle 32 is replaceable, device 10 can accommodate adjustments in operational pressures to achieve optimum velocity of a solution as it exits nozzle opening 36 and is impinged by concave depression 44 in impact area 42 of counter baffle 40. For example, and without being bound by theory, the vena contracts effect flow area regime in the minimum flow area of nozzle 32 (i.e., nozzle opening 36) assists in creating cavitation at (and before, in certain nozzle configurations) the point at which the solution exits nozzle opening 36 because the pressure of the solution is reduced significantly immediately upon exit. Such conditions cause a rapid reduction in pressure below the vapor pressure of the solution, thereby creating conditions necessary for cavitation.

The physical properties of an emulsion output can be controlled by the specific and variable design features of the device of the present invention. With further reference to FIG. 4, device 10 is highly efficient at creating, for example, dispersed phase emulsion droplets in the low micrometer (micron) diameter range. In particular, device 10 can achieve dispersed phase emulsion droplets in a range from about 1 to 20 microns, preferably about 2 to 10 microns.

In one particular application, e.g., for water (the dispersed phase) in fuel (the continuous phase) emulsions, emulsion droplets in a range of about 2-10 microns can be achieved, which is typically the most desirable range for this type of emulsion. The emulsion (water and hydrocarbon fuel) resulting from this particular use of device 10 has the benefit of reducing the amount of hydrocarbon fuel used to produce heat for industrial and other production and propulsion applications. In addition, this particular application can achieve benefits in water-in-fuel emulsions by reducing polluting emissions such as green house gases (GHG).

The device of the present invention is particularly beneficial in its design capability to control the essential quality factors of an emulsion output from device 10. Replaceable nozzle 32 and adjustable counter baffle 40 are particularly suited for offering such control. In particular, adjustable counter baffle 40 helps maximize and optimize the phenomenon of cavitation in cavitation chamber 14. With further reference to FIG. 4, the distance of impact area 42 of counter baffle 40 can be adjusted to widen or narrow volumetric channel 62, to permit adjustability of pressure and flow velocity of a solution. This, in turn, permits control of the diameter (size) and distribution of the dispersed phase droplets in the emulsion produced in cavitation chamber 14.

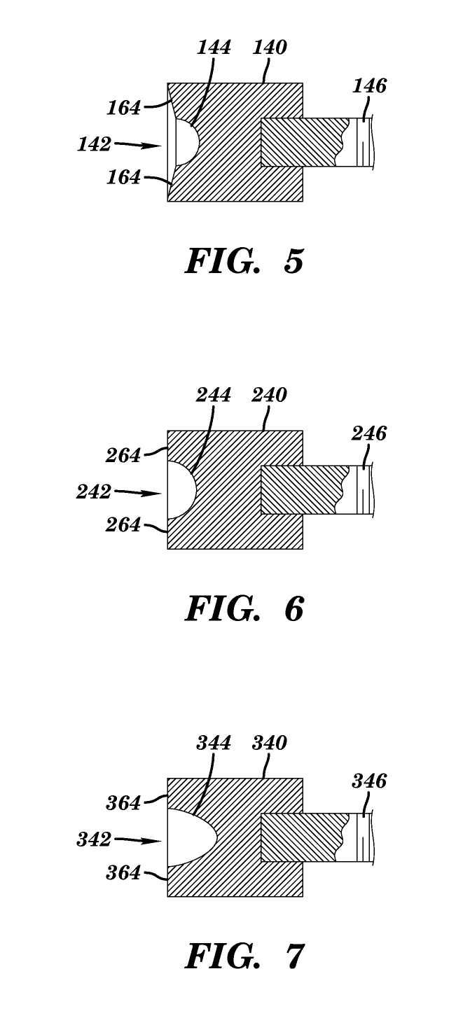

The device of the present invention also permits specific design and adaptation of concave depression 44 of the counter baffle that impinges flow of solution exiting nozzle 32. Concave depression 44 is specifically designed and positioned properly (for each different class of application) within chamber 14 to provide a unique control surface that permits a variety of additional control capabilities for adjusting the quality parameters of the emulsion ultimately produced at the output of device 10. As illustrated in FIGS. 5-7, the adjustable counter baffle of the device of the present invention may be modified in various ways to optimize the quality parameters of the emulsion output from the device. Altering the particular design of the impact area of the adjustable counter baffle varies the circumferential land area and may also vary the angle of the volumetric channel created inside the cavitation chamber. The size and shape of the impact area is an important variable in the initial stage turbulent mixing. Typically, the contact surface is planar, except for an area of indentation. In one embodiment, the design of the concave depression has a maximum diameter perpendicular to the center-line of the cavitation chamber that is larger than the diameter of the exit opening of the nozzle. The particular design features of the concave depression contribute to the control of the level of turbulence of the solution in the cavitation chamber. For example, the shape, size, and depth of the concave depression may be varied, e.g., spherical or parabolic in cross-section. Other cross-sectional shapes can be used. In the particular embodiment illustrated in FIG. 5, impact area 142 has indentation 144, which is a concave indentation. In addition, circumferential land area 164 of contact surface 142 is angled toward indentation 144. In the embodiment illustrated in FIG. 6, indentation 244 is relatively shallow, creating a more shallow indentation at impact area 242. In the embodiment shown in FIG. 7, indentation 344 is a parabolic shape, with a relatively deep indentation at impact area 342. The impact area of the counter baffle may be of any size or shape, depending on the particular use of the device of the present invention.

The ability to control and adjust the emulsion quality parameters in the device of the present invention is a salient and novel feature of the present invention. Such control and adjustment is achieved through proper design selection of a replaceable nozzle, adjustability of the counter baffle position, the design of the surface and shape of the concave depression of the counter baffle, and the location and width of the circumferential land area. Such features allow control of many variables of the emulsion producing process including, but not limited to, the pressure of the solution, the temperature and flow parameters of the solution through the nozzle opening; the absolute viscosities of the immiscible components of the solution and the ratios of their respective viscosities; the vapor partial pressures of the components of the solution; and the pressure and flow parameters downstream of the nozzle discharging through the volumetric channel and cavitation chamber.

With reference again to FIG. 4, as it pertains to replaceable nozzle 32, this component can be adjusted to alter the acceleration of upstream fluid velocity to a high value while creating at the same time a significant reduction in pressure (below the vapor pressure of the dispersed phase). Changes in the operating process parameters of the fluids can initiate violent cavitation while rapidly increasing turbulence, at relatively low Reynolds Numbers (just beyond 2100), with highly energetic eddy currents before exiting nozzle 32 and volumetric channel 62. The average diameter of the dispersed phase droplets formed during this initial onset of cavitation is directly proportional to the energy density and size of turbulent eddies formed. These effects can be impacted by the particular design of nozzle 32 selected.

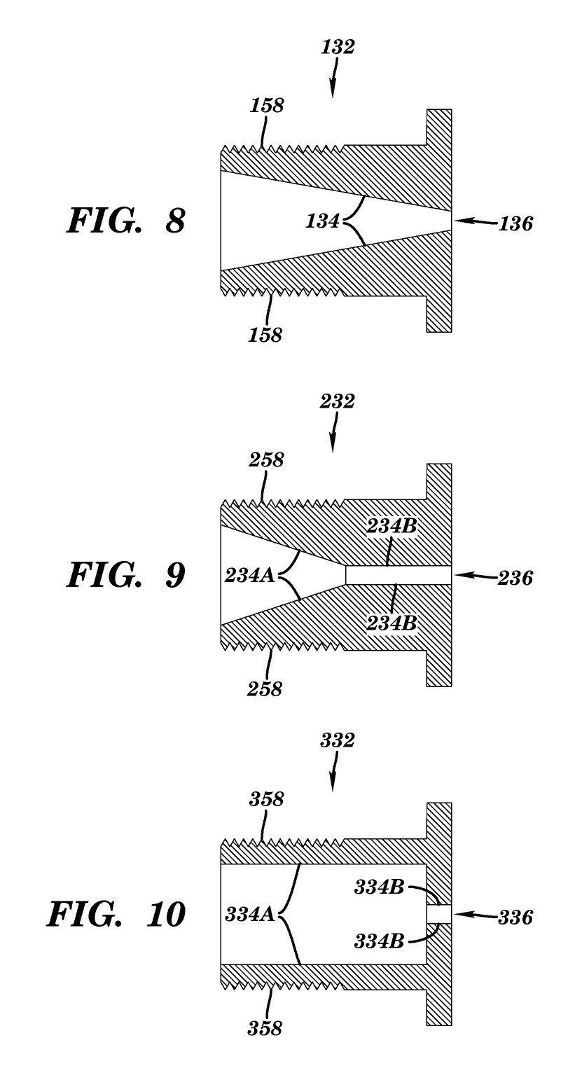

Three particular examples of nozzle designs are illustrated in FIGS. 8-10. In FIG. 8, nozzle 132 has convergent walls 134 that taper to their narrowest point at nozzle opening 136. Nozzle 132 has male threads 158 that engage with a female threaded bore in the device of the present invention to hold nozzle 132 in place.

In the embodiment illustrated in FIG. 9, length of small cylindrical channel 234B in nozzle 232 provides a means for forming the fluids into a more focused high velocity hydraulic jet into the concave depression of the counter baffle. The formation, shape and dissipation of this jet into the concave depression is controlled primarily by the length of small cylindrical channel 234B and the contour of the inner edge of nozzle opening 236. The shape and dissipation formation of the exiting fluid jet from nozzle 232 is matched with an appropriate shape for the concave depression in the counter baffle to best control the fluid's subsequent flow velocity, energy content, and cavitation turbulence conditions between the nozzle and the circumferential land area in the counter baffle. Before the fluids begin to exit nozzle 232 they experience turbulent and cavitating flow patterns that are developed in small cylindrical channel 234B of nozzle 232. The turbulent and cavitating flow patterns are created as a result of the sudden and dramatic pressure head build up in the fluids in convergent section 234A of nozzle 232 being converted to velocity head of the fluid in small cylindrical channel 234B. This continuous conversion process near the inlet side of small cylindrical channel 234B propels the fluids at a significant increase in velocity (approximately a factor of 10 greater than that in the upstream side of nozzle 232) with a corresponding significant decrease in local absolute fluid pressure (below the vapor partial pressure of the water in the fluid flow stream and creating classical cavitation conditions). During this period and as the cavitating and turbulent fluids flow out of opening 236 of nozzle 232, micron sized water droplets are formed by the eddy currents created in the cavitating flow patterns and are similar in size to these eddy currents. Nozzle 232 has male threads 258 that engage with a female threaded bore in the device of the present invention to hold nozzle 232 and the cavitation insert in place.

In the embodiment illustrated in FIG. 10, nozzle 332 has broad channel 334A that transitions abruptly to narrow channel 334B, which leads to nozzle opening 336. Nozzle 332 has male threads 358 that engage with a female threaded bore in the device of the present invention to hold nozzle 332 in place.

With further reference to FIG. 4, upon solution coming into contact with concave depression 44, which serves as the second stage of mixing/cavitation of the emulsion, a fluid flow directional change is implemented, as illustrated by the direction arrows in FIG. 4. Thus, the particular shape of concave depression 44 may be selected according to, e.g., spherical or parabolic reflector physics principles and the size may be selected according to process fluid properties for the unique emulsion product desired. Concave depression 44 assists in developing the final desired emulsion quality parameters, which are strongly influenced by the initial physical properties of the dispersed and continuous phases of immiscible fluid components. For example, immiscible fluid components are normally easier to process into an emulsified product if their viscosities are low and the ratio of their viscosities is within a certain predetermined range of values.

With further reference to FIG. 4, circumferential land area 64 provides a land area which defines volumetric channel 62 between circumferential land area 64 and nozzle 32. Volumetric channel 62 also assists in controlling the quality parameters of the solution in cavitation chamber 14. In particular, adjustmentability of the radial location width and/or length of volumetric channel 62 can be used to alter the velocity and pressure of the solution before it enters the more open area of cavitation chamber 14, thereby providing the necessary local process control capability to manipulate the quality parameters of the impacted fluids (i.e., beyond volumetric channel 62). The pressure and velocity of the solution in cavitation chamber 14 (i.e., beyond volumetric channel 62) is significantly reduced as the solution moves to exit port 22 and out of second opening 28. This reduction in pressure and velocity has the effect of stabilizing the dispersed phase quality of droplets. Circumferential land area 64 is, therefore, an integral design feature of the unique emulsion process occurring in device 10, inasmuch as this structural feature helps define volumetric channel 62 which is also an element of total control capability and operating scheme of the invention.

Volumetric channel 62 can have either parallel or asymmetrical side walls depending on the particular design of concave depression 44 and circumferential land area 64. For example, referring now to FIG. 5, circumferential land area 164 is angled, and would therefore form a volumetric channel with asymmetric side walls. In alternative embodiments illustrated in FIG. 6 and FIG. 7, circumferential land areas 264 (FIGS. 6) and 364 (FIG. 7) would form parallel side walls for a volumetric channel. This particular ability to adjust the size or shape of volumetric channel 62 permits an additional degree of capability for control of local fluid process parameters that can influence the emulsion quality parameters. Specifically, as a solution traverses the volumetric channel to reach the remainder of cavitation chamber 14, the solution is subjected to a local adjustment in process control parameters as may be needed to tailor the quality parameters of the emulsion. The capability of the range of control of the local process parameters in volumetric channel 62 can be precisely and accurately determined by the dimensions of volumetric channel 62.

With reference again to FIG. 4, the width of volumetric channel 62 can be adjusted by the distance of counter baffle 40 from nozzle 32. This is done by adjusting stem 46, which extends through opening 52 of back wall 54. Any suitable adjustment mechanism may be employed to adjust the distance of counter baffle 40 from nozzle 32. In the particular embodiment illustrated in FIG. 1 and FIG. 2, stem 46 has threaded spindle portion 68, which mates with threads inside of opening 52. According to this embodiment, handle 66 is included at distal end 50 of stem 46, whereby adjustment of handle 66 increases or decreases the distance between nozzle 32 and counter baffle 40, thereby increasing or decreasing the width of volumetric channel 62.

Referring again to FIG. 4, the dimensions of volumetric channel 62 contribute to the total control scheme for the quality parameters of the dispersed phase droplets including size, quantity, size distribution, and resolution of the distribution peak of phase droplets. This control capability (i.e., adjusting the size of volumetric channel 62 to control dispersed phase droplet properties) in conjunction with the ability to use various sizes, shapes, and diameters of concave depression 44 of the counter baffle to determine solution flow in cavitation chamber 14, contributes to the overall capability of the device of the present invention to be adjusted to optimize an emulsion product.

An additional controllable feature of device 10 of the present invention is the backpressure of cavitation chamber 14 (outside of volumetric channel 62), which can influence the final stabilized quality parameters of the exiting emulsion flow from the invention. This backpressure may be controlled, for example, by the use of standard flow control devices in exit port 22 and/or second opening 28.

Another aspect of the present invention relates to a method of emulsifying a mixture. This method involves providing the device of the present invention and introducing a mixture into the first opening of the device. The mixture passes through the nozzle and is emulsified in the cavitation chamber. An emulsified solution is recovered from the second opening of the device.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A device for emulsifying a mixture comprising:
a body defining a cavitation chamber, the body comprising a first and second opening and the cavitation chamber comprising an entry port and an exit port, wherein the first opening is connected to the entry port by which a mixture enters the body and the cavitatation chamber to be emulsified and the second opening is connected to the exit port by which emulsified solution exits the cavitation chamber and the body;
a replaceable nozzle positioned in the entry port of the cavitation chamber to direct flow of solution into the cavitation chamber; and
an adjustable counter baffle positioned in the cavitation chamber at a position to impinge flow of solution entering the cavitation chamber from the nozzle, wherein the counter baffle is moveably attached to the body to allow adjustment of distance between the counter baffle and the nozzle.

2. The device according to claim 1, wherein the first opening of the body is connected to the entry port of the cavitation chamber via a channel.

3. The device according to claim 2, wherein the channel has parallel walls.

4. The device according to claim 1, wherein the exit port of the cavitation chamber is at a position perpendicular to the entry port of the cavitation chamber.

5. The device according to claim 1, wherein the counter baffle comprises an impact area, wherein flow of solution from the nozzle is impinged in the cavitation chamber by the counter baffle at the impact area.

6. The device according to claim 5, wherein the impact area of the counter baffle comprises a depression.

7. The device according to claim 6, wherein the depression is a concave depression.

8. The device according to claim 6, wherein the impact area is perpendicular to the flow and is planar, except for the depression, and the depression is less than the entire impact area.

9. The device according to claim 5, wherein the impact area is perpendicular to the flow of solution from the nozzle into the cavitation chamber.

10. The device according to claim 5, wherein the impact area has an axial projected surface diameter greater than the diameter of the opening of the nozzle.

11. The device according to claim 5, wherein the impact area is not in contact with an interior wall of the cavitation chamber.

12. The device according to claim 5, wherein the counter baffle is attached to a wall defining the cavitation chamber, said wall being opposite the entry port of the cavitation chamber.

13. The device according to claim 12 further comprising:
a stem extending through the body and into the cavitation chamber through a wall opposite the entrance port, wherein the stem is connected at a first end to the counter baffle inside the cavitation chamber to support the counter baffle and at a second end to a handle outside the body to adjust the distance of the impact area to or from the nozzle.

14. The device according to claim 13, wherein the stem comprises a threaded spindle that mates with threads in the wall opposite the entry port of the cavitation chamber.

15. The device according to claim 1, wherein the body comprises a material selected from the group consisting of stainless steel and alloy materials.

16. The device according to claim 1, wherein the nozzle comprises a channel having a convergent shape.

17. The device according to claim 16, wherein the channel has a non-convergent portion.

18. A method of emulsifying a mixture, said method comprising:
providing the device according to claim 1;
introducing a mixture into the first opening, wherein the mixture passes through the nozzle and is emulsified in the cavitation chamber; and
recovering an emulsified solution from the second opening.

19. The method according to claim 18, wherein the mixture comprises two or more immiscible liquids.

20. The method according to claim 18, wherein the mixture comprises solid phase particles.

21. The method according to claim 18, wherein the mixture comprises gas phase particles.

22. The method according to claim 18, wherein the mixture comprises solid and gas phase particles.

23. The method according to claim 18, wherein the first opening of the body is connected to the entry port of the cavitation chamber via a channel.

24. The method according to claim 23, wherein the channel has parallel walls.

25. The method according to claim 18, wherein the exit port of the cavitation chamber is at a position perpendicular to the entry port of the cavitation chamber.

26. The method according to claim 18, wherein the counter baffle comprises an impact area, wherein flow of mixture from the nozzle is cavitated at a time selected from before, during, and after, or any combination thereof, exiting the nozzle and is impinged in the cavitation chamber by the counter baffle at the impact area to turbulently mix the solution.

27. The method according to claim 26, wherein the impact area of the counter baffle comprises a depression.

28. The method according to claim 27, wherein the depression is a concave depression.

29. The method according to claim 27, wherein the impact area is planar except for the depression and the depression is less than the entire impact area.

30. The method according to claim 26, wherein the impact area is perpendicular to the flow of solution from the nozzle into the cavitation chamber.

31. The method according to claim 26, wherein the impact area has an axial projected surface diameter greater than the diameter of the opening of the nozzle.

32. The method according to claim 26, wherein the impact area is not in contact with an interior wall of the cavitation chamber.

33. The method according to claim 18, wherein the counter baffle is attached to a wall defining the cavitation chamber, said wall being opposite the entry port of the cavitation chamber.

34. The method according to claim 33 further comprising:
a stem extending through the body and into the cavitation chamber through a wall opposite the entrance port, wherein the stem is connected at a first end to the counter baffle inside the cavitation chamber to support the counter baffle and at a second end to a handle outside the body to adjust the distance of the impact area to or from the nozzle.

35. The method according to claim 34, wherein the stem comprises a threaded spindle that mates with threads in the wall opposite the entry port of the cavitation chamber.

36. The method according to claim 34 further comprising:
adjusting the properties of the emulsified solution recovered from the device by adjusting the handle.

37. The method according to claim 18, wherein the nozzle has a convergent shape.

38. The method according to claim 18, wherein said introducing comprises introducing a pressurized mixture into the first opening.

39. The method according to claim 18 further comprising:
adjusting the pressure in the cavitation chamber by adjusting the rate at which the emulsified solution is recovered from the second opening.
